(19) United States
(12) Patent Application Publication
(10) Pub. No.: US 2003/0066081 A1
(43) Pub. Date: Apr. 3, 2003

(54) Command protocol for interactive TV production tools

(76) Inventors: Samuel T. Barone JR., Culver City, CA (US); Drake Smith, Oxford, CT (US)

Correspondence Address: CHRISTIE, PARKER & HALE, LLP, P.O. BOX 7068, PASADENA, CA, 91109-7068, US

(21) Appl. No.: 10/208,362

(22) Filed: Jul. 29, 2002

Related U.S. Application Data
(60) Provisional application No. 60/308,219, filed on Jul. 27, 2001.

(51) Int. Cl. H04N 7/173; H04N 7/16; G06F 15/16; G06F 9/00; G06F 9/46; H04N 7/00; H04N 11/00; H04N 7/18

(52) U.S. Cl. 725/80; 348/461; 348/460; 348/465; 725/136; 725/133; 725/141; 709/328; 709/237

(57) ABSTRACT

A command protocol enables an applications programming interface (API) between a first interactive television (ITV) equipment and a second ITV equipment for seamless communication between the two. An API command generator receives data from the first ITV equipment in a first format. The data may be, for example, a list of ITV events to be encoded into a television program. The command generator converts data into a second format according to the API and transmits the data in the second format to the second ITV equipment. The second ITV equipment may be, for example, an ITV data encoder encoding the list of ITV events transmitted by the first ITV equipment.

### CROSS-REFERENCE TO RELATED APPLICATIONS

This application claims the benefit of U.S. Provisional Patent application Serial No. 60/308,219, filed Jul. 27, 2001, the content of which is incorporated herein by reference.

### FIELD OF THE INVENTION

The present invention relates generally to interactive television production, encoding, and broadcasting systems and methods, and more particularly, to a command protocol for communication and interface between various interactive television-related production tools.

### BACKGROUND OF THE INVENTION

Interactive television (ITV) combines conventional television with additional interactive content to present a viewer with an enhanced version of a television program or commercial. Typically, the interactive content is in some way related to the television program being viewed, such as biographical information about one of the actors in the program, additional information about a topic covered in the program, and the like.

In order to allow a viewer to experience an enhanced television program, a broadcaster encodes the television program with ITV data and broadcasts the encoded television program to the viewers. The ITV data may take many forms, such as, for example, HTML, XML, JAVA, or JAVA Script commands. If the receiving viewer's television system is equipped with an ITV receiver, the ITV receiver may decode the embedded ITV data for accessing the associated interactive content or performing an action indicated by the command.

There are a number of issues that broadcasters must overcome when encoding ITV data into a television program. One issue arises from the use of different ITV devices, such as various ITV creation software, editing software, and encoders, or from the use of ITV devices made by different manufacturers. The ITV devices that are used typically do not share a common command protocol by which the devices may seamlessly communicate with one another to produce, encode, and broadcast interactive television content. This often leads to added expense and inconvenience for producers and broadcasters who are forced to buy additional equipment to enable such communication.

Accordingly, what is desired is a command protocol that will allow seamless communication among different interactive television devices without the need of additional equipment.

### SUMMARY OF THE INVENTION

According to one embodiment, a command protocol enables an applications programming interface between different interactive television production, encoding, and broadcasting devices, including network-enabled connections. The invention preferably eliminates several pieces of equipment, which can save money and increase reliability, obviously a paramount concern for broadcasters and other users of interactive television-related equipment.

According to one embodiment, the invention is directed to a method for communicating between a first ITV equipment and a second ITV equipment. The method includes receiving data from the first ITV equipment in a first format, converting the data from the first format to a second format, and transmitting the data in the second format to the second ITV equipment. According to one embodiment, the second format is defined by an application programming interface.

In another embodiment, the invention is directed to an ITV production system that includes a first ITV equipment, a second ITV equipment, and a processing device coupled between the first ITV equipment and the second ITV equipment. The first ITV equipment transmits data in a first format, and the processing device converts the data from the first format to a second format and transmits the data in the second format to the second ITV equipment.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE FIGURES

FIG. 1 is a block diagram of an ITV system that allows seamless communication between different ITV devices according to one embodiment of the invention;

FIG. 2 is a conceptual block diagram of a communication flow between a command generator and an encoder according an exemplary API command protocol;

FIG. 3 is a flow diagram of an exemplary process for encoding ITV data into a television program based on the API command protocol described with respect to FIG. 2 according to one embodiment of the invention;

FIG. 4 is a process flow diagram of an exemplary set of API commands that may be generated and transmitted by the command generator of FIG. 2 according to one embodiment of the invention; and

Appendix A provides additional details of a command and control application program interface that enables communication between a client and an encoder according to one embodiment of the present invention.

### DETAILED DESCRIPTION

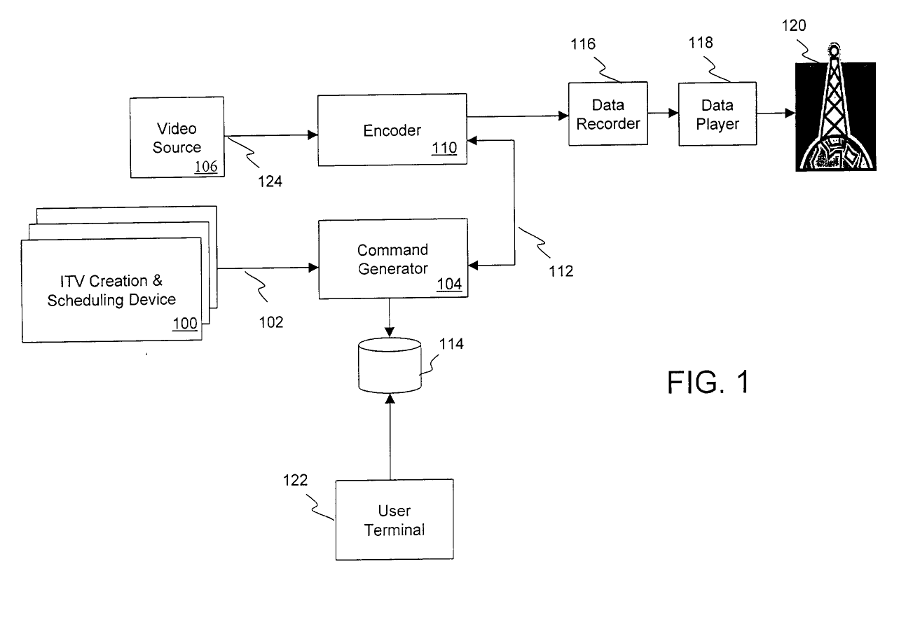

FIG. 1 is a block diagram of an ITV system that allows seamless communication between different ITV devices according to one embodiment of the invention. The ITV system illustrated in FIG. 1 includes an encoder 110 coupled to a video source 106 over a serial or network link 124, such as for example, a local area network (LAN) or wide area network (WAN) link. The video source 106 provides live or recorded video programs to the encoder for embedding ITV data into the video program. The ITV data may be embedded, for example, in the vertical blanking interval (VBI) (for example, line 21), or an MPEG 2 private data field (or a similar field of additional video formats) of the video portion of the program. The ITV data may be triggers, HTTP, XML, JAVA, or JAVA SCRIPT commands, URLs, and/or other type of ITV links, triggers, data sources, timing information, and data conventional in the art.

The encoder 110 may be an encoder conventional in the art, such as, for example, a DV2000 universal data encoder or ITV Injector, marketed by Ultech LLC, Middlebury, Conn. The video source 106 may be a camera, VCR, betacam, DVD player, PC, CD-ROM player, or any other device capable of delivering a video feed to the encoder 110.

The ITV system illustrated in FIG. 1 further includes an API command generator 102 coupled to the encoder 110 over link 112. Link 112 may allow for a serial, LAN, or WAN communication between the API command generator and encoder. The command generator 104 may reside as a software module in a dedicated, stand-alone computer or alternatively, may be incorporated into one or more existing ITV-related production equipment.

According to one embodiment of the invention, the command generator 102 enables a computer-based command and control application program interface (API) for seamless communication between a client and the encoder 110. The client may be, for example, a commercially available ITV creation and scheduling device 100 that provides a playlist of events to be embedded into a video program. The playlist may be remotely updated in real-time from an ITV network connected to the ITV device 100 via a serial, private network, or public network (Internet) connection.

The command generator 104 receives the playlist of events from the ITV device 100 over a serial or a private or public network link 102, and generates commands according to the API command protocol for causing the encoder 110 to insert the listed events into the video program. In this manner, seamless communication may be accomplished between the ITV device 100 and the encoder 110 even if each employs a different communication protocol. One of ordinary skill in the art would understand, however, that the API command protocol for seamless communication between the encoder and the ITV device may be readily applied to any number of ITV production, encoding, and broadcasting equipment, including devices manufactured by companies other than Mixed Signals Technologies, and does not only apply to communications between an ITV creation and scheduling device and an encoder.

The command generator 104 is further coupled to an API database 114 with command and control information for interacting with the encoder 110. Information stored in the database 114 may be generated, modified, and/or deleted by an operator via a user terminal 122 connected to the hardware device via a serial, private network, or Internet connection.

Once the ITV data is encoded in a video program, the modified program is output by the encoder 110 and may be recorded by a data recorder 116 for subsequent broadcast. At an appropriate time, the video program with the embedded ITV data is broadcast via a data player 118 and a broadcast station 120.

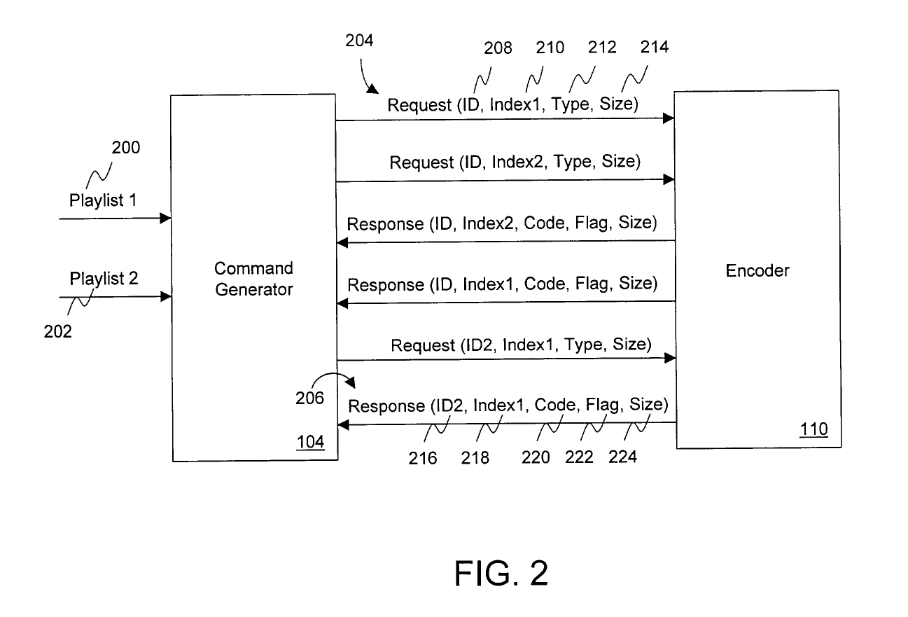

FIG. 2 is a conceptual block diagram of a handshaking sequence between the command generator 104 and the encoder 110 according an exemplary API. In the illustrated embodiment, the command generator receives portions of one or more running playlists 200, 202 generated by one or more ITV creation and scheduling devices 100. Each playlist may include arbitrary text strings that are forwarded as serial messages to the command generator 104. The command generator receives the serial messages and translates them into API commands for the encoder in accordance with the exemplary API.

According to one embodiment, the API allows for asynchronous command completion notification as well as concurrent request handling. An exemplary API utilizes a request 204 and response 206 protocol wherein a request made by the command generator on behalf of an ITV device 100 follows the request protocol, and a response made by the encoder 110 in response to the request follows the response protocol 206. A request, according to this embodiment, includes a channel ID parameter 208 and a request index parameter 210. The channel ID and request index may be used to associate each response with an originating request. In operation, since each response may be uniquely identified, responses need not necessarily follow requests in the order in which they were received. Multiple requests may be outstanding at any given time before a response is provided. The outstanding requests are queued by the encoder in a queue associated with the channel ID.

The channel ID value is generated by the encoder 110 in response to a request to open a new channel, and released in response to a request to close the channel. In opening a new channel, the encoder 110 determines the number of open channels that may be supported by the encoder at any time, and grants or denies a request to open the channel based on this determination. Once a channel is opened, the encoder assigns an ID value for the channel.

The request index value is maintained by the command generator 104 and assigned to a new request prior to transmitting the request. The request index is preferably unique throughout the life of the open channel.

A request generated according to the exemplary API further includes a request type parameter 212 that identifies the command that is being requested. The command may be, for example, to open a new channel, retrieve information about the encoder, request authorization for a channel, configure a channel for closed captioning or different types of teletext formats, write real-time closed captioning data, close a channel, or release authorization for a channel.

A request may also be accompanied by a parameter buffer that is preferably at least as large (in bytes) as the associated request. According to one embodiment, the request includes a size parameter 214 that indicates the size of the parameter buffer. The receiving encoder may determine that it has received the entire command by waiting for the request header to arrive plus as many bytes as are specified in the size parameter 214.

Upon receipt by the encoder 110 of a particular command generated according to the request protocol, the encoder transmits a response that includes a channel ID parameter 216 and a request index parameter 218. Together, the channel ID and request index parameters uniquely identify the request to which is being responded. Although a response is transmitted for each request, the response may be transmitted asynchronously and not according to the order of the associated request that was received. In addition, the encoder may process and generate responses to two or more requests in a concurrent manner.

According to one embodiment, a response transmitted by the encoder 110 includes a result code parameter 220 that indicates the outcome of the request as well as a result flag parameter 222 that indicates whether the current response record is the final record or if more response records are to follow. In the described exemplary embodiment, any command may be acknowledged by returning a no error result code and a result flag indicating that the encoder is still working on the request and that more response records are to be expected from the encoder until a result flag is returned indicating that the request has been completed.

According to one embodiment of the invention, certain types of requests require authorization from the encoder 110 before they are allowed to be performed for a particular ITV device 100. In this regard, a request authorization command is transmitted to the encoder 110 along with a command code of a command for which authorization is desired, and an authorization key. Upon receipt of a request for authorization, the encoder may verify that the requested command is authorized for the particular serial or network port that requested the authorization. This may be accomplished, for example, by comparing the authorization key for the command with a stored authorization key. If a match is made, the command is authorized for the requesting port.

If a match is not made, the encoder may respond to the request with an error code. An error code is also returned if a command is transmitted without a prior authorization request. The error code indicates that a transmitted command was ignored, and that a request for authorization is expected with the proper key before the command may be processed.

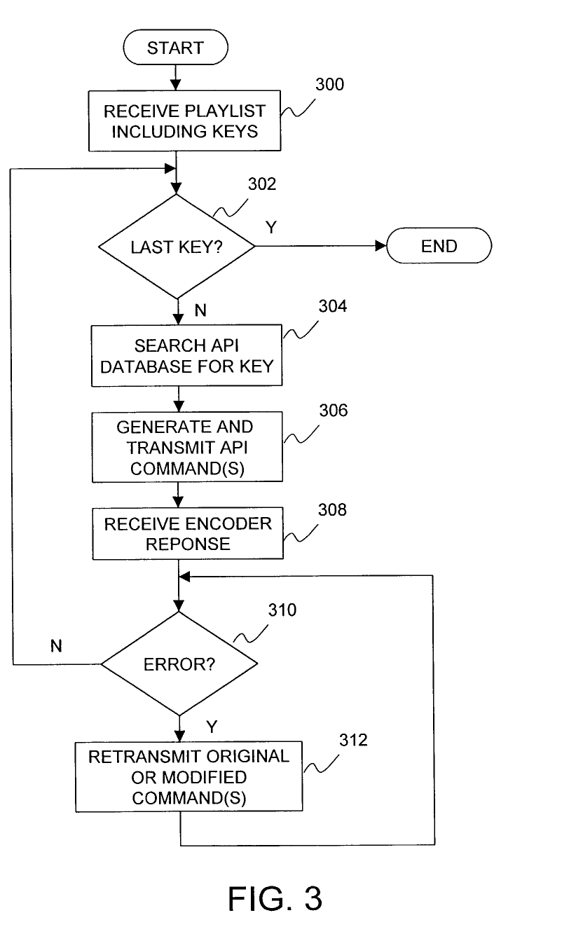

FIG. 3 is a flow diagram of an exemplary process for encoding ITV data into a television program based on the API described with respect to FIG. 2 according to one embodiment of the invention. The process starts, and in step 300, the command generator 104 receives a portion of a running playlist from the ITV device 100. The playlist may include a plurality of keys associated with events to be encoded into a television program. Each playlist entry with a key is preferably transmitted to the command generator 104 as a serial message. In step 302, the command generator 104 determines whether a last key of the playlist has been received. If the answer is NO, the command generator 104 proceeds translate a next key in the playlist into an API encoder command. This may be accomplished, for example, by searching the API database 114 for the key to be translated, and retrieving a associated API command code along with any optional parameter data.

In step 306, the command generator 104 generates and transmits API commands(s) as one or more API requests to the encoder 110. In step 308, the command generator receives an encoder response for each transmitted request. If the encoder response indicates an error, as determined in step 310, the command generator retransmits, in step 312, the erroneous command, or modifies one or more commands/requests and transmits the modified command/requests to the encoder 110.

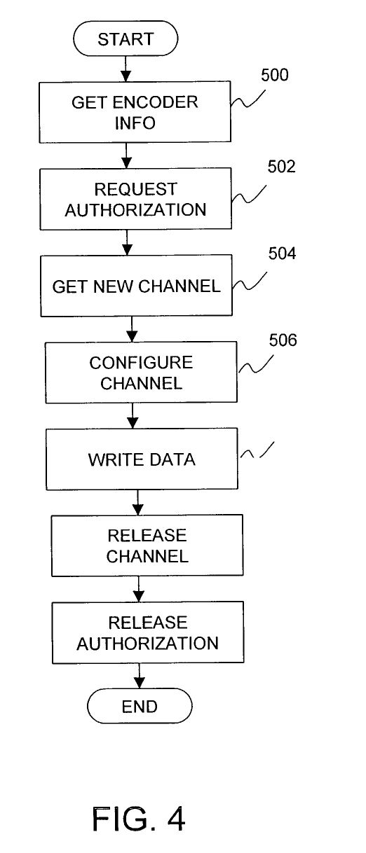

FIG. 4 is a process flow diagram of an exemplary set of API commands that may be generated and transmitted by the command generator 104 according to one embodiment of the invention. The process starts, and in step 500, the command generator 104 requests for encoder information. The information may include, for example, a version of the command API that is implemented.

In step 502, if a command to be transmitted requires authorization from the encoder, the command generator transmits an authorization request with an associated command code and a predetermined authorization key to the encoder. An exemplary command requiring authorization may be, for example, a request for a new open channel. Upon a grant of authorization from the encoder, the command generator may then transmit a request for the authorized command.

In the event that the authorized command for a new open channel, the command generator transmits, in step 504, a request that a new channel be allocated and opened. According to one embodiment, the command generator may open multiple channels, one for each type of service to be rendered, such as, for example, teletext, closed caption, and the like. The command generator may further request that the new channel be opened on a particular interface type. The available interface types are, for example, a default interface corresponding to the interface used to make the request for the new channel, a predetermined serial port, or an Ethernet port.

The encoder determines if a requested channel is available, and transmits the channel ID for the channel if available for use. According to one embodiment, the encoder 110 determines the port numbers to use, with the restriction that a unique port be used for each opened channel. If an Ethernet interface was requested, the encoder 110 may also return an IP address and a TCP port number to be used by the command generator for all subsequent calls for this channel number. For each channel that has been opened, the encoder maintains its state and configuration information as well as one or more buffers associated with the channel.

In step 506, the command generator transmits a channel configuration command telling the encoder 110 how the newly opened channel is to be configured. The configuration information informs the encoder 110 what to do with data written to and how to format the data read from it. According to one embodiment, channels may be configured for timecode (reading from the encoder), closed captions, NABTS teletext, world system teletext, and Japanese teletext.

In step 508, the command generator 104 transmits a channel write command to, the encoder 110 using the channel ID that was returned by the encoder. The channel write command includes the data to be written by the encoder. The data is preferably formatted according to the configuration information transmitted in step 506. In the case of closed captioning, the channel can be configured to encode EIA608 captions on line 21 of the video signal, or real time roll-up captions based on the ASCII text transmitted in real time.

The channel write command is transmitted by the command generator as many times as needed to encode the appropriate ITV data into the television program. The encoder may respond to the completion of each command in an asynchronous manner, and not necessarily in the order in which the commands where received.

In step 510, if all of the queued commands for the channel have been completed, the command generator releases the channel, its configuration, and the associated buffers and queues in the encoder. In step 512, the command generator transmits a request to release the authorization for the channel that was used. This results in any subsequent command from the channel other than a request for authorization to result in the encoder returning an error for lack of authorization.

Although this invention has been described in certain specific embodiments, those skilled in the art will have no difficulty devising variations which in no way depart from the scope and spirit of the present invention. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

[image]

[image]

[image]

[image]

[image]

[image]

[image]

[image]

[image]

[image]

[image]

[image]

[image]

[image]

[image]

[image]

What is claimed is:

1. A method for communicating between a first interactive television (ITV) equipment and a second ITV equipment, the method comprising:
receiving data from the first ITV equipment in a first format;
converting the data from the first format to a second format; and
transmitting the data in the second format to the second ITV equipment.

2. The method of claim 1, wherein the first ITV equipment is an ITV creation device.

3. The method of claim 1, wherein the second ITV equipment is an ITV data encoder.

4. The method of claim 1, wherein the second format corresponds to a format defined by an application program interface (API).

5. The method of claim 4, wherein the API provides for a handshaking sequence to be engaged with the second equipment.

6. The method of claim 5, wherein the handshaking sequence includes transmitting a request to the second equipment and receiving a response from the second equipment.

7. The method of claim 6, wherein the response uniquely identifies the request.

8. The method of claim 6, wherein an order of responses received from the second equipment differ from an order or requests transmitted to the second equipment.

9. An interactive television (ITV) production system comprising:
a first ITV equipment;
a second ITV equipment; and
a processing device coupled between the first ITV equipment and the second ITV equipment, characterized in that the first ITV equipment transmits data in a first format, and the processing device converts the data from the first format to a second format and transmits the data in the second format to the second ITV equipment.

10. The system of claim 9, wherein the first ITV equipment is an ITV creation device.

11. The system of claim 9, wherein the second ITV equipment is an ITV data encoder.

12. The system of claim 9, wherein the second format corresponds to a format defined by an application program interface (API).

13. The system of claim 12, wherein the API provides for a handshaking sequence to be engaged with the second equipment.

14. The system of claim 13, wherein the handshaking sequence includes transmitting a request to the second equipment and receiving a response from the second equipment.

15. The system of claim 14, wherein the response uniquely identifies the request.

16. The system of claim 14, wherein an order of responses received from the second equipment differ from an order or requests transmitted to the second equipment.
